(19) United States
(12) Patent Application Publication
(10) Pub. No.: US 2015/0017439 A1
(43) Pub. Date: Jan. 15, 2015

(54) BIO-BASED POLYMER BLENDS AND METHODS OF MAKING FIBERS

(71) Applicant: Interface, Inc., Atlanta, GA (US)

(72) Inventor: Luigi Pontarin, Folgaria (IT)

(21) Appl. No.: 14/328,100

(22) Filed: Jul. 10, 2014

Related U.S. Application Data
(60) Provisional application No. 61/845,026, filed on Jul. 11, 2013.

(51) Int. Cl. C08L 77/06; D01F 8/12; D01D 5/08; D01F 6/90

(52) U.S. Cl. CPC C08L 77/06; D01F 6/905; D01F 8/12; D01D 5/08
USPC 428/373; 525/183; 428/401; 428/397; 264/176.1

(57) ABSTRACT

Polymer blends include bio-based polymers or copolymers with post-consumer and/or post-industrial polymers or copolymers and a compatibilizer. Fibers may be prepared from the polymer blends. In addition, a life cycle analysis of the polymer blends may be superior in at least four of seven categories of the life cycle analysis relative to virgin polyamide 6.6. Methods of making the fibers from polymer blends are also described. The polymer blends are particularly useful in flooring applications, such as carpeting.

### RELATED APPLICATION

This application claims the benefit of U.S. Provisional Patent Application No. 61/845,026, filed Jul. 11, 2013, the disclosure of which is incorporated herein by this reference in its entirety.

### FIELD OF THE INVENTION

The present invention generally relates to polymer blends. More particularly, it relates to polymer blends containing a proportion of bio-based polymers, the fibers prepared therefrom, and methods of making fibers.

### BACKGROUND

Environmental performance of polymer products may be measured using a “cradle-to-grave” life-cycle assessment (LCA) approach. LCA evaluates all stages in the life of a product, including raw material acquisition, product manufacture, transportation, use and ultimately, recycling (i.e., “cradle to cradle” and waste management). Products that are bio-based, post-consumer-based, and/or post-industrial-based may improve their LCA profile.

Bio-based products, as defined by the 2002 U.S. Farm Bill, are commercial or industrial products (other than food or feed) that are composed in whole, or in significant part, of biological products, renewable agricultural materials (including plant, animal, and marine materials), or forestry materials. The 2008 U.S. Farm Bill extended the definition of bio-based products to include bio-based intermediate ingredients or feedstocks.

Flooring manufacturers have embraced sustainability for a number of important reasons, including reducing waste, improving manufacturing processes, and developing innovative, more environmentally-friendly flooring options. As a result of these efforts to minimize environmental impact, the standard synthetic raw materials utilized in the past in the flooring industry are now being replaced or used in conjunction with bio-based plant materials, such as corn starch, soybean oil, and castor bean oil.

Made from renewable resources, bio-based plant materials impact multiple aspects of the product life cycle. For example, they are typically harvested close to production facilities to reduce the carbon footprint and may result in fewer greenhouse gas emissions. In addition, they may require less energy to produce. Attractively, they may potentially save the manufacturer and the end user time and expenses associated with regulatory permits and compliance. Also, disposal issues are minimized or eliminated. In some cases, they are less toxic than synthetic materials.

Flooring manufacturers that have utilized bio-based technology in the engineering of residential and commercial flooring, including carpeting, have been challenged to find a way to achieve comparable levels of cost, affordability, durability, stain protection, softness, and aesthetics associated with nylon-based carpets using bio-based polymers containing plant matter.

It is desirable to increase the use of content from renewable sources, rather than petroleum-based resources, to further reduce dependency on oil. It is also necessary to reduce emissions of greenhouse gases and lower energy consumption. However, it is necessary that the products containing content from such renewable sources have processing and performance properties that are consistent with petroleum-based fiber, allowing for processing, performance, and environmental benefits, while being cost effective. The polymer blends and methods of the present invention are directed toward these, as well as other, important ends.

### SUMMARY

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

The invention is generally directed to polymer blends comprising bio-based polymers and/or copolymers with post-consumer and/or post-industrial polymers and/or copolymers and a compatibilizer are disclosed. The invention is also directed to fibers prepared from the polymer blends. In some embodiments, the polymers blends of the invention are superior in at least four of seven categories of the life cycle analysis relative to virgin polyamide 6.6. In further embodiments, the invention is directed to methods of making the fibers. The polymer blends are particularly useful in flooring applications, such as carpeting.

Accordingly, in one embodiment, the invention is directed to polymer blends, comprising:
about 10% by weight to about 50% by weight, based on the total weight of the polymer blend, of at least one bio-based polymer, bio-based copolymer, or a mixture thereof;
about 50%, by weight to about 90% by weight, based on the total weight of the polymer blend, of at least one post-consumer polymer, post-consumer copolymer, post-industrial polymer, post-industrial copolymer or a mixture thereof; and
at least one compatibilizer.

In other embodiments, the invention is directed to fibers, comprising a plurality of continuous filaments formed from the polymer blend described above.

In another embodiment, the invention is directed to polymer blends, comprising:
greater than about 50% by weight, based on the total weight of the polymer blend, of at least one bio-based polymer, bio-based copolymer, or a mixture thereof;
less than about 50% by weight, based on the total weight of the polymer blend, of at least one post-consumer polymer, post-consumer copolymer, post-industrial polymer, post-industrial copolymer or a mixture thereof; and
   less than about 5% by weight, based on the total weight of the polymer blend, of at least one compatibilizer;
wherein said at least one post-consumer polymer, post-consumer copolymer, post-industrial polymer, post-industrial copolymer or said mixture thereof is incompatible with said at least one bio-based polymer, bio-based copolymer, or said mixture thereof;
wherein a life cycle analysis of said polymer blend is superior in at least four of seven categories of said life cycle analysis relative to virgin polyamide 6.6; and
wherein said categories are selected from the group consisting of fossil energy, acidification, eutrophication, global warming, human toxicity, ozone depletion, and smog.

In other embodiments, the invention is directed to fibers, comprising a plurality of continuous filaments formed from the polymer blend described above.

In yet other embodiments, the invention is directed to methods of forming fibers, comprising the step:
providing at least one bio-based polymer, bio-based copolymer, or a mixture thereof;
providing at least one post-consumer polymer, post-consumer copolymer, post-industrial polymer, post-industrial copolymer or a mixture thereof;
providing at least one compatibilizer;
melt blending said at least one bio-based polymer, bio-based copolymer, or said mixture thereof with said at least one post-consumer polymer, post-consumer copolymer, post-industrial polymer, post-industrial copolymer or said mixture thereof, and said at least one compatibilizer to form a primary blend; and
extruding said primary blend through a spin plate to form fibers;
wherein said spin plate provides a shear rate of about 1,500 sec⁻¹ to about 4,000 sec⁻¹.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

### Definitions

As employed above and throughout the disclosure, the following terms, unless otherwise indicated, shall be understood to have the following meanings.

As used herein, the singular forms “a,” “an,” and “the” include the plural reference unless the context clearly indicates otherwise.

As used herein, the term “in significant part” means a composition having at least about 50% by weight, preferably at least about 70% by weight, and more preferably at least about 90% by weight, based on the total weight of the composition.

While the present invention is capable of being embodied in various forms, the description below of several embodiments is made with the understanding that the present disclosure is to be considered as an exemplification of the invention, and is not intended to limit the invention to the specific embodiments illustrated. Headings are provided for convenience only and are not to be construed to limit the invention in any manner. Embodiments illustrated under any heading may be combined with embodiments illustrated under any other heading.

The use of numerical values in the various quantitative values specified in this application, unless expressly indicated otherwise, are stated as approximations as though the minimum and maximum values within the stated ranges were both preceded by the word “about.” In this manner, slight variations from a stated value can be used to achieve substantially the same results as the stated value. Also, the disclosure of ranges is intended as a continuous range including every value between the minimum and maximum values recited as well as any ranges that can be formed by such values. Also disclosed herein are any and all ratios (and ranges of any such ratios) that can be formed by dividing a recited numeric value into any other recited numeric value. Accordingly, the skilled person will appreciate that many such ratios, ranges, and ranges of ratios can be unambiguously derived from the numerical values presented herein and in all instances such ratios, ranges, and ranges of ratios represent various embodiments of the present invention.

As used herein with reference to a polymer or a copolymer, “bio-based” means a component part, intermediate, or final product (other than food or feed) that contains in whole, or in significant part, biological products, renewable agricultural materials (including plant, animal, and marine materials), or forestry materials, and is to be contrasted with components, intermediates, and final product derived directly or indirectly from petroleum.

As used herein with reference to a polymer or a copolymer, “post-consumer” means a component part, intermediate, or final product that contains in whole, or in significant part, a waste material produced by the end consumer of a material stream.

As used herein with reference to a polymer or a copolymer, “post-industrial” means a component part, intermediate, or final product that contains in whole, or in significant part, a waste material produced prior to the end consumer of a material stream and which may be reintroduced as manufacturing scrap back into the same or different manufacturing process.

As used herein, “compatibilizer” means a polymeric additive that, when added to a blend of immiscible polymers or copolymers or mixtures thereof, modifies their interfaces and stabilizes the blend. Typical compatibilizers may be block or graft copolymers.

As used herein, “copolymer” means a polymer derived from more than one species of monomer. Copolymers that are obtained by copolymerization of two monomer species may be referred to as “bipolymers,” those obtained from three monomers “terpolymers,” those obtained from four monomers “quaterpolymers,” etc.

As used herein with reference to a polymer or a copolymer, “sustainable” refers to a polymer or copolymer that meets the needs of the end consumer while minimizing damage to the environment and the health of those in contact with the polymer or copolymer (and preferably being economically viable). The production of sustainable polymers and copolymers should use less net water and non-renewable energy, emit less greenhouse gases and have a smaller carbon-footprint than their non-sustainable counterparts, preferably while still being economically viable.

As used herein, “fiber” means a unit of matter characterized by having a length at least 100 times its diameter or width and which has a definite preferred orientation of its crystal unit cells with respect to a specific axis. A fiber may be made of one or more continuous or very long filaments or shorter, cut portions or a combination thereof.

As used herein, “(meth)acrylate” refers to both acrylate and methacrylate.

### Polymer Blends

Accordingly, in one embodiment, the invention is directed to polymer blends, comprising:
about 10% by weight to about 50% by weight, based on the total weight of the polymer blend, of at least one bio-based polymer, bio-based copolymer, or a mixture thereof;
about 50%, by weight to about 90% by weight, based on the total weight of the polymer blend, of at least one post-consumer polymer, post-consumer copolymer, post-industrial polymer, post-industrial copolymer or a mixture thereof; and
at least one compatibilizer.

In other embodiments, the invention is directed to fibers, comprising a plurality of continuous filaments formed from the polymer blend described above.

In certain embodiments, said post-consumer polymer, said post-consumer copolymer, said post-industrial polymer, said post-industrial copolymer, or said mixture thereof is incompatible with said bio-based polymer.

In certain embodiments of the polymer blends, said bio-based polymer is polyamide 11; and said post-consumer polymer or post-industrial polymer is polyamide 6. In preferred certain embodiments, said polyamide 11 is present at a level of about 30%, by weight, based on the total weight of the polymer blend; and said polyamide 6 is present at a level of about 70%, by weight, based on the total weight of the polymer blend. In certain other preferred embodiments, said polyamide 11 is present at a level of about 30%, by weight, based on the total weight of the polymer blend; said post-consumer polymer is present at a level of about 20%, by weight, based on the total weight of the polymer blend; and said post-industrial polymer is present at a level of about 50%, by weight, based on the total weight of the polymer blend. In certain embodiments of the polymer blend, said post-consumer polymer is polyamide 6; and said post-industrial polymer is polyamide 6.

In certain embodiments of the polymer blends, said bio-based polymer is polyamide 11; and said post-consumer polymer or post-industrial polymer is polyamide 6.6. In certain preferred embodiments, said polyamide 11 is present at a level of about 30%, by weight, based on the total weight of the polymer blend; and said polyamide 6.6 is present at a level of about 70%, by weight, based on the total weight of the polymer blend. In certain other preferred embodiments, said polyamide 11 is present at a level of about 30%, by weight, based on the total weight of the polymer blend; said post-consumer polymer is present at a level of about 20%, by weight, based on the total weight of the polymer blend; and said post-industrial polymer is present at a level of about 50%, by weight, based on the total weight of the polymer blend. In certain embodiments, said post-consumer polymer is polyamide 6.6; and said post-industrial polymer is polyamide 6.6.

In certain embodiments of the polymer blends, said bio-based polymer is polyamide 10.10; and said post-consumer polymer or post-industrial polymer is polyamide 6. In certain preferred embodiments, said polyamide 10.10 is present at a level of about 30%, by weight, based on the total weight of the polymer blend; and said polyamide 6 is present at a level of about 70%, by weight, based on the total weight of the polymer blend. In certain other preferred embodiments, said polyamide 10.10 is present at a level of about 30%, by weight, based on the total weight of the polymer blend; said post-consumer polymer is present at a level of about 20%, by weight, based on the total weight of the polymer blend; and said post-industrial polymer is present at a level of about 50%, by weight, based on the total weight of the polymer blend. In certain embodiments, said post-consumer polymer is polyamide 6; and said post-industrial polymer is polyamide 6.

In certain embodiments of the polymer blend, said bio-based polymer is polyamide 10.10; and said post-consumer polymer or post-industrial polymer is polyamide 6.6. In certain preferred embodiments, said polyamide 10.10 is present at a level of about 30%, by weight, based on the total weight of the polymer blend; and said polyamide 6.6 is present at a level of about 70%, by weight, based on the total weight of the polymer blend. In certain other preferred embodiments, said polyamide 10.10 is present at a level of about 30%, by weight, based on the total weight of the polymer blend; said post-consumer polymer is present at a level of about 20%, by weight, based on the total weight of the polymer blend; and said post-industrial polymer is present at a level of about 50%, by weight, based on the total weight of the polymer blend. In certain other embodiments, said post-consumer polymer is polyamide 6.6; and said post-industrial polymer is polyamide 6.6.

In certain embodiments of the polymer blend, said bio-based polymer is polyamide 6.10; and said post-consumer polymer or post-industrial polymer is polyamide 6. In certain preferred embodiments, said polyamide 6.10 is present at a level of about 30%, by weight, based on the total weight of the polymer blend; and said polyamide 6 is present at a level of about 70%, by weight, based on the total weight of the polymer blend. In certain other preferred embodiments, said polyamide 6.10 is present at a level of about 30%, by weight, based on the total weight of the polymer blend; said post-consumer polymer is present at a level of about 20%, by weight, based on the total weight of the polymer blend; and said post-industrial polymer is present at a level of about 50%, by weight, based on the total weight of the polymer blend. In other embodiments, said post-consumer polymer is polyamide 6; and said post-industrial polymer is polyamide 6.

In certain embodiments of the polymer blend, said bio-based polymer is polyamide 6.10; and said post-consumer polymer or post-industrial polymer is polyamide 6.6. In certain preferred embodiments, said polyamide 6.10 is present at a level of about 30%, by weight, based on the total weight of the polymer blend; and said polyamide 6.6 is present at a level of about 70%, by weight, based on the total weight of the polymer blend. In certain other preferred embodiments, said polyamide 6.10 is present at a level of about 30%, by weight, based on the total weight of the polymer blend; said post-consumer polymer is present at a level of about 20%, by weight, based on the total weight of the polymer blend; and said post-industrial polymer is present at a level of about 50%, by weight, based on the total weight of the polymer blend. In certain embodiments, said post-consumer polymer is polyamide 6.6; and said post-industrial polymer is polyamide 6.6.

In another embodiment, the invention is directed to second polymer blends, comprising:
greater than about 50% by weight, based on the total weight of the polymer blend, of at least one bio-based polymer, bio-based copolymer, or a mixture thereof;
less than about 50% by weight, based on the total weight of the polymer blend, of at least one post-consumer polymer, post-consumer copolymer, post-industrial polymer, post-industrial copolymer or a mixture thereof; and
   less than about 5% by weight, based on the total weight of the polymer blend, of at least one compatibilizer;
wherein said at least one post-consumer polymer, post-consumer copolymer, post-industrial polymer, post-industrial copolymer or said mixture thereof is incompatible with said at least one bio-based polymer, bio-based copolymer, or said mixture thereof;
wherein a life cycle analysis of said polymer blend is superior in at least four of seven categories of said life cycle analysis relative to virgin polyamide 6.6; and
wherein said categories are selected from the group consisting of fossil energy, acidification, eutrophication, global warming, human toxicity, ozone depletion, and smog.

In other embodiments, the invention is directed to fibers, comprising a plurality of continuous filaments formed from the polymer blend described above. In certain preferred embodiments, a life cycle analysis of said polymer blend is superior in at least five or six of seven categories of said life cycle analysis relative to virgin polyamide 6.6.

In certain embodiments of the second polymer blends, said at least one bio-based polymer, bio-based copolymer, or said mixture thereof is present at a level of greater than about 60% by weight, based on the total weight of the polymer blend; said at least one post-consumer polymer, post-consumer copolymer, post-industrial polymer, post-industrial copolymer or said mixture thereof is present at a level of less than about 40% by weight, based on the total weight of the polymer blend; and said at least one compatibilizer is present at a level of about 2%, by weight, to about 5%, by weight, based on the total weight of the polymer blend.

In certain embodiments of the second polymer blends, said at least one bio-based polymer, bio-based copolymer, or said mixture thereof is present at a level of about 65% by weight, to about 75% by weight, based on the total weight of the polymer blend; said at least one at least one post-consumer polymer, post-consumer copolymer, post-industrial polymer, post-industrial copolymer or said mixture thereof is present at a level of about 25% by weight to about 35%, based on the total weight of the polymer blend; and said at least one compatibilizer is present at a level of about 2%, by weight, to about 5%, by weight, based on the total weight of the polymer blend. In certain embodiments, said post-consumer polymer or said post-consumer copolymer or said mixture thereof is present at a level of about 20%, by weight, based on the total weight of the polymer blend; and said post-industrial polymer or post-industrial copolymer or said mixture thereof is present at a level of about 50%, by weight, based on the total weight of the polymer blend.

In certain embodiments of either of the polymer blends, when said polymer blend is molten, a portion of said at least one bio-based polymer forms nodules in said at least one post-consumer polymer or said at least one post-industrial polymer or said mixture thereof; wherein said nodules have a diameter less than about 4μ, preferably less than about wherein said nodules have a diameter less than about 2μ. Nodules that are larger than about 4μ may cause filtration problems.

In certain embodiments, the polymer blends comprise less than about 10% by weight, based on the total weight of the polymer blend, of a virgin counterpart of at least one post-consumer polymer, post-consumer copolymer, post-industrial polymer, post-industrial copolymer or said mixture thereof.

In certain embodiments, the polymer blends are at least about 95% sustainable.

### Bio-Based Components

In certain embodiments of either polymer blend of the invention, said bio-based polymer, said bio-based copolymer, or said mixture thereof is at least one polymer selected from the group consisting of polyamide 4.6, polyamide 4.10, polyamide 6.10, polyamide 6.12, polyamide 10.10, polyamide 10.12, polyamide 11, polyamide 12, polylactide, polytrimethylene terephthalate, and copolymers and mixtures thereof.

In certain embodiments of either polymer blend of the invention, said bio-based polymer is polyamide 4.6.

In certain embodiments of either polymer blend of the invention, said bio-based polymer is polyamide 4.10.

In certain embodiments of either polymer blend of the invention, said bio-based polymer is said bio-based polymer is polyamide 6.10.

In certain embodiments of either polymer blend of the invention, said bio-based polymer is said bio-based polymer is polyamide 6.12.

In certain embodiments of either polymer blend of the invention, said bio-based polymer is said bio-based polymer is polyamide 10.10.

In certain embodiments of either polymer blend of the invention, said bio-based polymer is said bio-based polymer is polyamide 10.12.

In certain embodiments of either polymer blend of the invention, said bio-based polymer is said bio-based polymer is polyamide 11.

In certain embodiments of either polymer blend of the invention, said bio-based polymer is said bio-based polymer is polyamide 12.

In certain embodiments of either polymer blend of the invention, said bio-based polymer is said bio-based polymer is polylactide (alternately known as polylactic acid).

In certain embodiments of either polymer blend of the invention, said bio-based polymer is said bio-based polymer is polytrimethylene terephthalate.

### Post-Consumer and Post-Industrial Components

In certain embodiments of either polymer blend of the invention, said post-consumer polymer, said post-consumer copolymer, said post-industrial polymer, said post-industrial copolymer, or said mixture thereof is selected from the group consisting of polyamide 6, polyamide 6.6, polyamide 4.6, polyamide 4.10, polyamide 6.10, polyamide 6.12, polyamide 10.10, polyamide 10.12, polyamide 11, polyamide 12, polylactide, polyethylene terephthalate, polytrimethylene terephthalate, polybutylene terephthalate, and copolymers and mixtures thereof.

In certain embodiments of either polymer blend of the invention, said post-consumer polymer or post-industrial polymer is polyamide 6.

In certain embodiments of either polymer blend of the invention, said post-consumer polymer or post-industrial polymer is polyamide 6.6.

### Compatibilizers

The polymer blends of the invention contain as one component at least one compatibilizer. The compatibilizer is preferably a thermoplastic polymer with polar groups. In preferred embodiments, the compatibilizer is bio-based.

In certain embodiments of either polymer blend of the invention, said at least one compatibilizer is present at a level of less than about 5%, preferably less than about 2%, by weight, based on the total weight of the polymer blend. In certain embodiments, the at least one compatibilizer is present at a level of about 2%, by weight, to about 5%, by weight, based on the total weight of the polymer blend.

In certain preferred embodiments, said compatibilizer is an ethylene-(C₂-C₁₂)alkyl(meth)acrylate-maleic anhydride copolymer. In certain embodiments, said ethylene is present at a level of about 70%, by weight, to about 90%, by weight, based on the total weight of the compatibilizer; said (C₂-C₁₂)alkyl(meth)acrylate about 3%, by weight, to about 15%, by weight, based on the total weight of the compatibilizer; and said maleic anhydride is present at a level of about 3%, by weight, to about 10%, by weight, based on the total weight of the compatibilizer. Suitable compatibilizers are commercially available, such as for example, under the Lotader™ series from Arkema, Inc. In certain embodiments of the compatibilizer, said (C₂-C₁₂)alkyl(meth)acrylate is a methyl acrylate, butyl acrylate, ethyl acrylate, glycidyl methacrylate, or a mixture thereof.

In certain embodiments, said compatibilizer is thermoplastic copolyamide. Suitable thermoplastic copolyamides are the polycondensation product of lauryllactam and caprolactam, such as, for example, commercially-available PLATAMID® 1 and PLATAMID® 2 from Arkema, Inc.

### Fibers

In certain embodiments, the invention is directed to fibers comprising a plurality of continuous filaments formed from the polymer blends described herein.

In certain embodiments, said fibers are dyed.

In certain embodiments, said fibers have a modification ratio of about 1.5 to about 3.0, preferably, about 1.9 to about 2.1.

In certain embodiments, said filaments are multilobal, preferably, trilobal.

In certain embodiments, a cross-section of said fiber comprises:
a portion of said at least one bio-based polymer, bio-based copolymer, or said mixture thereof in the form of fibrils;
a portion of said at least one bio-based polymer, bio-based copolymer, or said mixture thereof in the form of an incompatible outer layer.

While not wishing to bound by theory, it is believed that the fibrils provide reinforcement and thus improve the mechanical properties. It is also believed that the incompatible outer layer is less water sensitive and thus improves the stain resistance of the fibers.

In certain embodiments, said fibrils have an average diameter of about 0.1μ to about 1μ and an average length of about 100μ to about 500μ. In certain preferred embodiments, said fibrils have an average diameter of about 0.5μ and an average length of about 400μ.

In certain embodiments, each of said filaments comprises:
a core of said at least one post-consumer polymer, post-consumer copolymer, post-industrial polymer, post-industrial copolymer or said mixture thereof; and
a sheath of said at least one bio-based polymer, bio-based copolymer, or said mixture thereof.

The polymer blends and fibers are particularly useful in flooring applications, such as industrial and residential carpeting.

### Methods of Forming Fibers

In yet other embodiments, the invention is directed to methods of forming fibers, comprising the step:
providing at least one bio-based polymer, bio-based copolymer, or a mixture thereof;
providing at least one post-consumer polymer, post-consumer copolymer, post-industrial polymer, post-industrial copolymer or a mixture thereof;
providing at least one compatibilizer;
melt blending said at least one bio-based polymer, bio-based copolymer, or said mixture thereof with said at least one post-consumer polymer, post-consumer copolymer, post-industrial polymer, post-industrial copolymer or said mixture thereof, and said at least one compatibilizer to form a primary blend; and
extruding said primary blend through a spin plate to form fibers;
wherein said spin plate provides a shear rate of about 1,500 sec⁻¹ to about 4,000 sec⁻¹, preferably, 2,000 sec⁻¹ to about 3,000 sec⁻¹.

In certain embodiments, said spin plate comprising a plurality of capillaries; wherein said capillaries have a capillary height of about 0.5 mm to about 1.0 mm.

In certain embodiments, said capillaries have a length to diameter ratio of about 2 to about 4.

In certain embodiments, said fibers have a modification ratio of about 1.9 to about 2.1.

The present invention is further defined in the following Examples, in which all parts and percentages are by weight, unless otherwise stated. It should be understood that these examples, while indicating preferred embodiments of the invention, are given by way of illustration only and are not to be construed as limiting in any manner. From the above discussion and these examples, one skilled in the art can ascertain the essential characteristics of this invention, and without departing from the spirit and scope thereof, can make various changes and modifications of the invention to adapt it to various usages and conditions.

### EXAMPLES

### Example 1: Polymer Blend of Bio-Based Polyamide 11 and Post-Consumer Polyamide 6

Bio-based polyamide 11
Specific density: 1.05 g/cm³
Intrinsic viscosity: 1.0-1.05 dL/g (meta-cresol)
Shear viscosity at 2500 sec⁻¹: 100-150 Pa·s at 250° C.
Level: 20-40% by weight, based on the total weight of polymer blend

Post-consumer polyamide 6
Specific density: 1.25 g/cm³
Intrinsic viscosity: 1.25-1.35 dL/g (meta-cresol)
Shear viscosity at 2500 sec⁻¹: 100-150 Pa·s at 260° C.
Ash content: 2% maximum
Filter test (AP): 0.04 daN/g after 2 ore with filtration (15 μm)
Thermal stability: variation of viscosity less than 5% after 20 minutes at 300° C.
Level: 60-80% by weight, based on the total weight of polymer blend

Compatibilizer
90.5/6/3.5 polyethylene/acrylic ester/maleic anhydride (Lotader 3210)
Melt flow index: 6-9 grams of polymer/10 minutes of flow time
Level: 2-5%, by weight, based on the total weight of the polymer blend

### Example 2: Polymer Blend of Bio-Based Polyamide 11 and Post-Consumer Polyamide 6.6

Bio-based polyamide 11
Specific density: 1.05 g/cm³
Intrinsic viscosity: 1.0-1.05 dL/g (meta-cresol)
Shear viscosity at 2500 sec⁻¹: 150-200 Pa·s at 280° C.
Level: 20-40% by weight, based on the total weight of polymer blend

Post-consumer polyamide 6.6
Specific density: 1.25 g/cm³
Intrinsic viscosity: 1.25-1.35 dL/g (meta-cresol)
Shear viscosity at 2500 sec⁻¹: 100-150 Pa·s at 260° C.
Ash content: 2% maximum
Filter test (ΔP): 0.04 daN/g after 2 ore with filtration (15 μm)
Thermal stability: variation of viscosity less than 5% after 20 minutes at 300° C.
Level: 60-80% by weight, based on the total weight of polymer blend

Compatibilizer
90.5/6/3.5 polyethylene/acrylic ester/maleic anhydride (Lotader 3210)
Melt flow index: 6-9 grams of polymer/10 minutes of melt flow
Level: 2-5%, by weight, based on the total weight of the polymer blend

### Example 3: Blend Method

Using the blend compositions of Example 1 and Example 2, the bio-based polymer, the post-consumer polymer and the compatibilizer were mixed in the main feeder for a sufficient time to compatibilize the components.

A twin extruder was employed. The screw profile introduced some shear to get a good mixing in the melting zone with the following parameters for the melting zone:
two kneading block at 45°
two kneading block at 90°
a left handed element
temperature of 250° C. and 260° C. so that the viscosities of the bio-based polymer and the post-consumer polymer are sufficiently melted but not too fluid so that there is efficient mixing of the components. The melt blend was pelletized and cooled.

### Example 4: Fiber Extrusion

The polymer blends prepared in Example 3 were dried at 70° C. for 4 to 6 hours to reach moisture between 200 and 500 ppm and then processed as follows.
Filtration: metallic screen 325 mesh (molten polymer)
Extruder mono screw: 28/30:1d
Extrusion at 265° C.
Draw ratio: 3.0-3.5
Quench air temperature: 12-16° C.
First roll temperature: 50° C.
First draw roll temperature: 120° C.
Heat setting roll temperature: 160° C.
Texturizing jet temperature: 170° C.
Spin plate: 58 holes (trilobal)

The average properties of the bulked continuous filament (BCF) fiber, based on count: 1250/58 denier, using, for example, a Testometric Micro 350 tensile tester using a gauge length of 500 mm and a test speed of 300 mm/minute) are shown below:
Tenacity: 3.3-3.5 grams/denier
Elongation: 45-48%
Crimp: 22-25%

While the preferred forms of the invention have been disclosed, it will be apparent to those skilled in the art that various changes and modifications may be made that will achieve some of the advantages of the invention without departing from the spirit and scope of the invention. Therefore, the scope of the invention is to be determined solely by the claims to be appended.

When ranges are used herein for physical properties, such as molecular weight, or chemical properties, such as chemical formulae, all combinations, and subcombinations of ranges specific embodiments therein are intended to be included.

The disclosures of each patent, patent application, and publication cited or described in this document are hereby incorporated herein by reference, in their entirety.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A polymer blend, comprising:
about 10% by weight to about 50% by weight, based on the total weight of the polymer blend, of at least one bio-based polymer, bio-based copolymer, or a mixture thereof;
about 50%, by weight to about 90% by weight, based on the total weight of the polymer blend, of at least one post-consumer polymer, post-consumer copolymer, post-industrial polymer, post-industrial copolymer or a mixture thereof; and
at least one compatibilizer.

2. The polymer blend of claim 1,
wherein the at least one compatibilizer is present at a level of less than about 5%, by weight, based on the total weight of the polymer blend.

3. The polymer blend of claim 1,
wherein the compatibilizer is a bio-based polymer.

4. The polymer blend of claim 1,
wherein the compatibilizer is an ethylene-(C₂-C₁₂)alkyl(meth)acrylate-maleic anhydride copolymer.

5. The polymer blend of claim 1,
wherein the ethylene is present at a level of about 70%, by weight, to about 90%, by weight, based on the total weight of the compatibilizer;
wherein the (C₂-C₁₂)alkyl(meth)acrylate about 3%, by weight, to about 15%, by weight, based on the total weight of the compatibilizer; and
wherein the maleic anhydride is present at a level of about 3%, by weight, to about 10%, by weight, based on the total weight of the compatibilizer.

6. The polymer blend of claim 5,
wherein the (C₂-C₁₂)alkyl(meth)acrylate is a methyl acrylate, butyl acrylate, ethyl acrylate, glycidyl methacrylate, or a mixture thereof.

7. The polymer blend of claim 1,
wherein the compatibilizer is thermoplastic copolyamide.

8. The polymer blend of claim 1,
wherein the post-consumer polymer, the post-consumer copolymer, the post-industrial polymer, the post-industrial copolymer, or the mixture thereof is incompatible with the bio-based polymer.

9. The polymer blend of claim 1,
wherein the bio-based polymer, the bio-based copolymer, or the mixture thereof is present at a level of about 25% by weight to about 35% by weight, based on the total weight of the polymer blend; and
wherein the post-consumer polymer, the post-consumer copolymer, the post-industrial polymer, the post-industrial copolymer, or the mixture thereof is present at a level of about 65%, by weight to about 75% by weight, based on the total weight of the polymer blend.

10. The polymer blend of claim 1,
wherein the bio-based polymer, the bio-based copolymer, or the mixture thereof is at least one polymer selected from the group consisting of polyamide 4.6, polyamide 4.10, polyamide 6.10, polyamide 6.12, polyamide 10.10, polyamide 10.12, polyamide 11, polyamide 12, polylactide, polytrimethylene terephthalate, and copolymers and mixtures thereof.

11. The polymer blend of claim 1,
wherein the post-consumer polymer, the post-consumer copolymer, the post-industrial polymer, the post-industrial copolymer, or the mixture thereof is selected from the group consisting of polyamide 6, polyamide 6.6, polyamide 4.6, polyamide 4.10, polyamide 6.10, polyamide 6.12, polyamide 10.10, polyamide 10.12, polyamide 11, polyamide 12, polylactide, polyethylene terephthalate, polytrimethylene terephthalate, polybutylene terephthalate, and copolymers and mixtures thereof.

12. The polymer blend of claim 1,
wherein the bio-based polymer, the bio-based copolymer, or the mixture thereof is at least one polymer selected from the group consisting of polyamide 11, polyamide 10.10 and polyamide 6.10 and is present at a level of about 30%, by weight, based on the total weight of the polymer blend; and
wherein the post-consumer polymer, the post-consumer copolymer, the post-industrial polymer, the post-industrial copolymer, or the mixture thereof is selected from the group consisting of polyamide 6 and polyamide 6.6 and is present at a level of about 70%, by weight, based on the total weight of the polymer blend.

13. The polymer blend of claim 1,
wherein, when the polymer blend is molten, a portion of the at least one bio-based polymer forms nodules in the at least one post-consumer polymer or the at least one post-industrial polymer or the mixture thereof;
wherein the nodules have a diameter less than about 4μ.

14. A fiber comprising a plurality of continuous filaments formed from the polymer blend of claim 1.

15. The fiber of claim 14,
wherein the fibers have a modification ratio of about 1.5 to about 3.0.

16. The fiber of claim 14,
wherein the filaments are multilobal.

17. The fiber of claim 14,
wherein a cross-section of the fiber comprises:
a portion of the at least one bio-based polymer, bio-based copolymer, or the mixture thereof in the form of fibrils;
a portion of the at least one bio-based polymer, bio-based copolymer, or the mixture thereof in the form of an incompatible outer layer.

18. The fiber of claim 17,
wherein the fibrils have an average diameter of about 0.1μ to about 1μ and an average length of about 100μ to about 500μ.

19. The fiber of claim 14,
wherein each of the filaments comprises:
a core of the at least one post-consumer polymer, post-consumer copolymer, post-industrial polymer, post-industrial copolymer or the mixture thereof; and
a sheath of the at least one bio-based polymer, bio-based copolymer, or the mixture thereof.

20. A polymer blend, comprising:
greater than about 50% by weight, based on the total weight of the polymer blend, of at least one bio-based polymer, bio-based copolymer, or a mixture thereof;
less than about 50% by weight, based on the total weight of the polymer blend, of at least one post-consumer polymer, post-consumer copolymer, post-industrial polymer, post-industrial copolymer or a mixture thereof; and
less than about 5% by weight, based on the total weight of the polymer blend, of at least one compatibilizer;
wherein the at least one post-consumer polymer, post-consumer copolymer, post-industrial polymer, post-industrial copolymer or the mixture thereof is incompatible with the at least one bio-based polymer, bio-based copolymer, or the mixture thereof;
wherein a life cycle analysis of the polymer blend is superior in at least four of seven categories of the life cycle analysis relative to virgin polyamide 6.6; and
wherein the categories are selected from the group consisting of fossil energy, acidification, eutrophication, global warming, human toxicity, ozone depletion, and smog.

21. The polymer blend of claim 20, further comprising:
less than about 10% by weight, based on the total weight of the polymer blend, of a virgin counterpart of at least one post-consumer polymer, post-consumer copolymer, post-industrial polymer, post-industrial copolymer or the mixture thereof.

22. The polymer blend of claim 20,
wherein a life cycle analysis of the polymer blend is superior in at least five of seven categories of the life cycle analysis relative to virgin polyamide 6.6.

23. The polymer blend of claim 20,
wherein the at least one bio-based polymer, bio-based copolymer, or the mixture thereof is present at a level of greater than about 60% by weight, based on the total weight of the polymer blend;
wherein the at least one post-consumer polymer, post-consumer copolymer, post-industrial polymer, post-industrial copolymer or the mixture thereof is present at a level of less than about 40% by weight, based on the total weight of the polymer blend; and
wherein the at least one compatibilizer is present at a level of about 2%, by weight, to about 5%, by weight, based on the total weight of the polymer blend.

24. The polymer blend of claim 20,
wherein the bio-based polymer is at least one polymer selected from the group consisting of polyamide 4.6, polyamide 4.10, polyamide 6.10, polyamide 6.12, polyamide 10.10, polyamide 10.12, polyamide 11, polyamide 12, polylactide, polytrimethylene terephthalate, and copolymers and mixtures thereof.

25. The polymer blend of claim 20,
wherein the post-consumer polymer or post-industrial polymer is selected from the group consisting of polyamide 6, polyamide 6.6, polyamide 4.6, polyamide 4.10, polyamide 6.10, polyamide 6.12, polyamide 10.10, polyamide 10.12, polyamide 11, polyamide 12, polylactide, polyethylene terephthalate, polytrimethylene terephthalate, polybutylene terephthalate, and copolymers and mixtures thereof.

26. The polymer blend of claim 20,
wherein, when the polymer blend is molten, a portion of the at least one bio-based polymer, bio-based copolymer, or the mixture thereof forms nodules in the at least one post-consumer polymer, post-consumer copolymer, post-industrial polymer, post-industrial copolymer or the mixture thereof;
wherein the nodules have a diameter less than about 4μ.

27. A fiber comprising a plurality of continuous filaments formed from the polymer blend of claim 20.

28. The fiber of claim 27,
wherein the fibers have a modification ratio of about 1.5 to about 3.0.

29. A method of forming fibers, comprising:
providing at least one bio-based polymer, bio-based copolymer, or a mixture thereof;
providing at least one post-consumer polymer, post-consumer copolymer, post-industrial polymer, post-industrial copolymer or a mixture thereof;
providing at least one compatibilizer;
melt blending the at least one bio-based polymer, bio-based copolymer, or the mixture thereof with the at least one post-consumer polymer, post-consumer copolymer, post-industrial polymer, post-industrial copolymer or the mixture thereof, and the at least one compatibilizer to form a primary blend; and
extruding the primary blend through a spin plate to form fibers;
wherein the spin plate provides a shear rate of about 1,500 sec⁻¹ to about 4,000 sec⁻¹.

30. The method of claim 29,
wherein the spin plate comprises a plurality of capillaries;
wherein the capillaries have a capillary height of about 0.5 mm to about 1.0 mm.

31. The method of claim 30,
wherein the capillaries have a length to diameter ratio of about 2 to about 4 and the fibers have a modification ratio of about 1.5 to about 3.0.
